(19) United States
(12) Patent Application Publication
(10) Pub. No.: US 2017/0329062 A1
(43) Pub. Date: Nov. 16, 2017

(54) OPTICAL FILM AND FLEXIBLE DEVICE USING THE OPTICAL FILM

(71) Applicant: SUMITOMO CHEMICAL COMPANY, LIMITED, Tokyo (JP)

(72) Inventors: Hideaki NAKAJIMA, Ichihara-shi (JP); Takashi SAKURAI, Tsukuba-shi (JP); Katsunori MOCHIZUKI, Osaka-shi (JP); Boram PYEON, Tsukuba-shi (JP)

(73) Assignee: SUMITOMO CHEMICAL COMPANY, LIMITED, Tokyo (JP)

(21) Appl. No.: 15/587,695

(22) Filed: May 5, 2017

(30) Foreign Application Priority Data
May 10, 2016 (JP) 2016-094528

(51) Int. Cl. G02B 5/22; C08K 5/3475; C08J 5/18; C08K 5/3467; G02B 5/20; C08K 5/3492

(52) U.S. Cl. CPC G02B 5/223; G02B 5/208; C08K 5/3492; C08J 5/18; C08K 5/3467; C08K 5/3475; C08J 2379/08

(57) ABSTRACT

To improve an optical film containing a polyimide-based polymer and the like and used for a front plate of a flexible device member, in terms of improvement of hygroscopic characteristics and achievement of high transparency, less coloring, and satisfactory ultraviolet absorption. Disclosed is an optical film containing a polyimide-based polymer and/or polyamide and an ultraviolet absorbent. A light transmittance of the optical film is not more than 5% at 380 nm and not less than 80% at 420 nm.

### BACKGROUND OF THE INVENTION

### Field of the Invention

The present invention relates to an optical film and a flexible device member using the optical film.

### Description of the Related Art

In general, in order to protect members likely to be degraded by ultraviolet radiation, such as liquid crystal and polarizing films, a device such as a display includes films and the like containing an ultraviolet absorbent as protective films or optical films as a front plate and the like (JP-A-2002-350644, JP-A-2007-217667, and JP-A-2010-083980).

On the other hand, as a transparent member of a flexible device substituting for glass, use of a polyimide film is being studied (JP-A-2014-133887 and WO 2014/051050). A polyimide film tends to have hygroscopicity higher than that of a triacetyl cellulose film conventionally used as a protective film. Further, the polyimide film tends to have flexibility and strength higher than those of a norbornene film.

### SUMMARY OF THE INVENTION

However, concerning an optical film containing a polyimide-based polymer, polyamide, and the like, hygroscopic characteristics and the like are required to be further improved, and it has been difficult to achieve a performance capable of satisfying all of high transparency (Haze<1), less coloring (YI<5), and satisfactory ultraviolet absorption.

Thus, it is an object of an aspect of the present invention is to improve an optical film containing a polyimide-based polymer and the like in terms of hygroscopic characteristics, high transparency (Haze<1), less coloring (YI<5), and satisfactory ultraviolet absorption.

An aspect of the present invention relates to an optical film containing the following polyimide-based polymer and/or polyamide and an ultraviolet absorbent. Another aspect of the present invention relates to a flexible device comprising the optical film.

[1] An optical film containing at least one selected from the group consisting of a polyimide-based polymer and polyamide, and an ultraviolet absorbent, wherein a light transmittance at 380 nm is not more than 5%, and a light transmittance at 420 nm is not less than 80%.
[2] The optical film as described in [1] above, wherein the light transmittance is not more than 32% at 390 nm.
[3] The optical film as described in [1] or [2] above, wherein the light transmittance is not more than 30% at 390 nm.
[4] The optical film as described in any one of [1] to [3] above, wherein the polyimide-based polymer is polyimide soluble in a polar solvent, and a yellow index of the optical film is not more than 5.
[5] The optical film as described in any one of [1] to [4] above, wherein the ultraviolet absorbent is a compound to be dissolved in an amount of not less than 1 g in 100 g of N,N-dimethylacetamide at 25° C.
[6] The optical film as described in any one of [1] to [5] above, wherein a molar extinction coefficient at 380 nm of the ultraviolet absorbent is not less than five times the molar extinction coefficient at 400 nm.
[7] The optical film as described in any one of [1] to [6] above, wherein the ultraviolet absorbent contains one or more kinds of compounds selected from the group consisting of a benzotriazole derivative and a 1,3,5-triphenyltriazine derivative.
[8] The optical film as described in [7] above, wherein the ultraviolet absorbent is one or more kinds of compounds selected from the group consisting of a compound represented by the formula (I);
2-[2-hydroxy-3-(3,4,5,6-tetrahydrophthalimide-methyl)-5-methylphenyl] benzotriazole; 2,2′-Methylenebis[6-(2H-benzotriazole-2-yl)-4-tert-octylphenol];
Reaction products of methyl 3-(3-(2H-benzotriazole-2-yl)-5-tert-butyl-4-hydroxyphenyl) propionate/PEG 300;
and a compound represented by the formula (II).

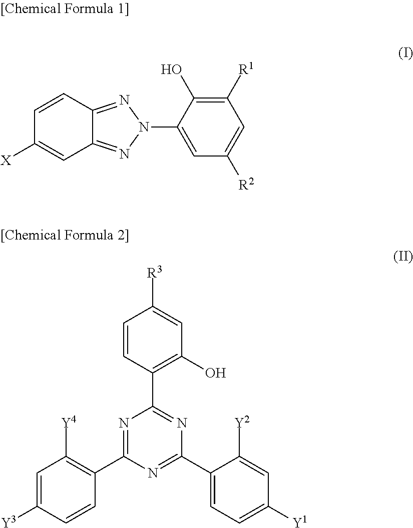

In the formula (I), X denotes a hydrogen atom, a fluorine atom, a chlorine atom, an alkyl group having 1 to 5 carbon atoms, or an alkoxy group having 1 to 5 carbon atoms, R¹ and R² each denote a hydrogen atom or a hydrocarbon group having 1 to 20 carbon atoms, and at least one of R¹ and R² is a hydrocarbon group.

In the formula (II), Y¹ to Y⁴ each independently denote a hydrogen atom, a fluorine atom, a chlorine atom, a hydroxy group, an alkyl group having 1 to 20 carbon atoms, or an alkoxy group having 1 to 20 carbon atoms, and R³ denotes a hydrogen atom, a hydrocarbon group having 1 to 20 carbon atoms, an alkoxy group having one oxygen atom and 1 to 20 carbon atoms, or an alkoxy group having 1 to 4 carbon atoms substituted with an alkyl keto oxy group having 1 to 12 carbon atoms.

[9] The optical film as described in any one of [1] to [8] above, wherein silica particles having an average primary particle size of 10 to 100 nm are contained in an amount of not less than 10% by mass and not more than 60% by mass of an optical film containing silica particles and at least one selected from a polyimide-based polymer and polyamide.
[10] The optical film as described in any one of [1] to [9] above, which is used for a front plate of a flexible device member.
[11] A flexible device comprising the optical film as described in any one of [1] to [10] above.

According to an aspect of the present invention, there is provided a polyimide-based optical film which has improved hygroscopic characteristics, high transparency, and less coloring, satisfactorily absorbs ultraviolet radiation, and is used for a front plate of a flexible device member and the like.

### DETAILED DESCRIPTION OF THE PREFERRED EMBODIMENTS

Hereinafter, some embodiments of the present invention will be described in detail. However, this invention is not limited to the following embodiments.

In this specification, polyimide is a polymer containing a repeating structural unit containing an imide group, and polyamide is a polymer containing a repeating structural unit containing an amide group. A polyimide-based polymer denotes polyimide and a polymer containing a repeating structural unit containing both an imide group and an amide group. Examples of the polymer containing a repeating structural unit containing both an imide group and an amide group include polyamideimide.

An optical film according to an embodiment is a single-layer transparent resin film containing a polyimide-based polymer and/or polyamide and an ultraviolet absorbent. A total light transmittance of the optical film is preferably not less than 90%.

A light transmittance of the optical film according to the embodiment is not more than 5% at 380 nm and not less than 80% at 420 nm. By virtue of the use of such a film, low yellow index and excellent visibility are obtained, and, at the same time, constructional elements inside a device can be satisfactorily protected from ultraviolet radiation. From a similar viewpoint, the light transmittance of the optical film is preferably not more than 4% at 380 nm. The light transmittance at 390 nm of the optical film is preferably not more than 32%, more preferably not more than 30%, particularly preferably not more than 20%, and the most preferably not more than 15%.

In general, even in a transparent resin film containing an ultraviolet absorbent, it is unlikely that the light transmittances at 380 nm and 420 nm simultaneously fall within the specified ranges as described above. However, when an ultraviolet absorbent having a high absorption performance to light at 380 nm and high permeability to light at 400 nm and 420 nm is selected considering the solubility characteristics to N,N-dimethylacetamide (hereinafter also referred to as “DMAc”), a transparent resin film having the absorption characteristics as described above can be obtained as an optical film.

The yellow index of the optical film is usually not more than 5, preferably not more than 4, and more preferably not more than 3. Further, the yellow index of the optical film is usually not less than 0.5. A film having such a low yellow index can contribute to high visibility of a flexible device.

As described above, the optical film according to this embodiment can be obtained as an optical film which contains an ultraviolet absorbent in such an amount that allows the light transmittances at 380 nm and 420 nm to fall within the specified ranges to have improved hygroscopic characteristics and less coloring and satisfactorily absorb ultraviolet radiation while maintaining high transparency.

A laminated film may be obtained by combining the optical film with other layers. In this case, it is preferable that the entire laminated film have the light absorption characteristics as described above.

The ultraviolet absorbent is preferably a compound to be dissolved in an amount of not less than 1 g in 100 g of DMAc at 25° C. The solubility of the ultraviolet absorbent is preferably not less than 5 g/100 g and more preferably not less than 10 g/100 g to a solvent, such as DMAc and the like. There is no upper limit to the solubility of the ultraviolet absorbent, and the upper limit may be 100 g/100 g, for example. Since an ultraviolet absorbent having high solubility with respect to DMAc is easily homogenized with a polyimide-based polymer and polyamide, the ultraviolet absorbent can improve hygroscopic characteristics and exhibit the ultraviolet absorption in the film while maintaining high transparency of an optical film. Improve of hygroscopic characteristics means suppressing a water absorption rate.

The reason for suppressing a water absorption rate is not clear but presumed as follows. A polyimide-based polymer and polyamide exhibit high solubility with respect to N,N-dimethylacetamide. Accordingly, it is presumed that since an ultraviolet absorbent having high solubility with respect to N,N-dimethylacetamide is particularly easily homogenized with a polyimide-based polymer and polyamide, the ultraviolet absorbent can satisfactorily exhibit ultraviolet absorption action due to the ultraviolet absorbent while maintaining transparency of an optical film and can remove moisture and the like. Consequently, it is considered that it is possible to obtain an optical film which has improved hygroscopic characteristics and less coloring and satisfactorily absorb ultraviolet radiation while maintaining high transparency.

The ultraviolet absorbent can be selected from compounds which have solubility with respect to DMAc, as described above, and at the same time have such light absorption characteristics that can achieve not more than 5% of the light transmittance of an optical film at 380 nm and not less than 80% of the light transmittance at 420 nm.

In this context, a compound selected as the ultraviolet absorbent is preferably a compound in which, with respect to a molar extinction coefficient ε₃₈₀ at 380 nm and a molar extinction coefficient ε₄₀₀ at 400 nm, ε₄₀₀/ε₃₈≧5. The compound selected as the ultraviolet absorbent is more preferably a compound in which ε₄₀₀/ε₃₈₀≧10 and particularly preferably a compound in which ε₄₀₀/ε₃₈₀≧20.

Examples of the ultraviolet absorbent include a benzotriazole derivative (benzotriazole-based ultraviolet absorbent), a triazine derivative (triazine-based ultraviolet absorbent), a benzophenone derivative (benzophenone-based ultraviolet absorbent), and a salicylate derivative (salicylate-based ultraviolet absorbent), and at least one selected from the group consisting thereof can be used. At least one selected from the group consisting of a benzotriazole-based ultraviolet absorbent and a triazine-based ultraviolet absorbent is preferably used, and the benzotriazole-based ultraviolet absorbent is more preferably used.

As one of preferred aspects of the present invention, a benzotriazole-based ultraviolet absorbent is preferably used in an optical film containing a polyimide-based polymer (in particular, polyimide and polyamideimide). Specifically, there are exemplified the compound represented by the following formula (I), the trade name “Sumisorb (registered trademark) 250” (2-[2-Hydroxy-3-(3,4,5,6-tetrahydrophthalimidomethyl)-5-met hylphenyl])benzotriazole manufactured by Sumitomo Chemical Co., Ltd., and the trade names “Tinuvin (registered trademark) 360” (2,2′-Methylenebis[6-(benzotriazole-2-yl)-4-tert-octylphenol]) and “Tinuvin (registered trademark) 213” (Reaction products of methyl 3-(3-(2H-benzotriazole-2-yl)-5-tert-butyl-4-hydroxyphenyl) propionate/PEG300); both manufactured by BASF Japan Ltd. These can be used alone or in combination of two or more kinds thereof. Specific examples of the compound represented by the following formula (I) include the trade names “Sumisorb 200” (2-(2-hydroxy-5-methylphenyl)benzotriazole), “Sumisorb 300” (2-(3-tert-butyl-2-Hydroxy-5-methylphenyl)-5-chlorobenzotriazole), “Sumisorb 340” (2-(2-hydroxy-5-tert-octylphenyl)benzotriazole), and “Sumisorb 350” (2-(2-hydroxy-3, 5-di-tert-pentylphenyl)benzotriazole) all manufactured by Sumitomo Chemical Co., Ltd., the trade names “Tinuvin (registered trademark) 327” (2-(2′-Hydroxy-3′,5′-di-tert-butylphenyl)-5-chlorobenzotriazole), “Tinuvin (registered trademark) 571” (2-(2H-benzotriazo-2-yl)-6-dodecyl-4-methyl-phennol), and “Tinuvin (registered trademark) 234” (2-(2H-Benzotriazole-2-yl)-4,6-bis(l-methyl-1-phenylethyl)phenol) all manufactured by BASF Japan Ltd., and the trade name “LA31” (2,2′-methylenebis[6-(2H-benzotriazole-2-yl)-4-(1,1,3,3-tetramethylbutyl)phenol]) manufactured by ADEKA Corporation. Preferred are the compound represented by the following formula (I) and the trade name “Tinuvin (registered trademark) 213” (Reaction products of methyl 3-(3-(2H-benzotriazole-2-yl)-5-tert-butyl-4-hydroxyphenyl) propionate/PEG 300).

More preferred are the trade names “Sumisorb 200” (2-(2-hydroxy-5-methylphenyl)benzotriazole), “Sumisorb 300” (2-(3-tert-butyl-2-hydroxy-5-methylphenyl)-5-chlorobenzotriazole), “Sumisorb 340” (2-(2-Hydroxy-5-tert-octylphenyl)benzotriazole), and “Sumisorb 350” (2-(2-hydroxy-3, 5-di-tert-pentylphenyl)benzotriazole) all manufactured by Sumitomo Chemical Co., Ltd., the trade name “LA31” (2,2′-methylenebis[6-(2H-benzotriazole-2-yl)-4-(1,1,3,3-tetramethylbutyl)phenol]) manufactured by ADEKA Corporation, and the trade names “Tinuvin (registered trademark) 327” (2-(2′-hydroxy-3′,5′-di-tert-butylphenyl)-5-chlorobenzotriazole) and “Tinuvin (registered trademark) 571” (2-(2H-benzotriazo-2-yl)-6-dodecyl-4-methyl-phennol) both manufactured by BASF Japan Ltd. Most preferred are the trade names “Sumisorb 340” (2-(2-hydroxy-5-tert-octylphenyl)benzotriazole) and “Sumisorb 350” (2-(2-hydroxy-3, 5-di-tert-pentylphenyl)benzotriazole) both manufactured by Sumitomo Chemical Co., Ltd. and the trade name “LA31” (2,2′-methylenebis[6-(2H-benzotriazole-2-yl)-4-(1,1,3,3-tetramethylbutyl)phenol]) manufactured by ADEKA Corporation.

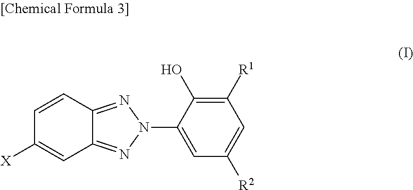

In the formula (I), X denotes a hydrogen atom, a fluorine atom, a chlorine atom, an alkyl group having 1 to 5 carbon atoms, or an alkoxy group having 1 to 5 carbon atoms. In the formula (I), R¹ and R² each denote a hydrogen atom or a hydrocarbon group having 1 to 20 carbon atoms, and at least one of R¹ and R² is a hydrocarbon group having 1 to 20 carbon atoms. When R¹ and R² each denote a hydrocarbon group, R¹ and R² each preferably denote a hydrocarbon group having 1 to 12 carbon atoms and more preferably denote a hydrocarbon group having 1 to 8 carbon atoms, and a methyl group, a tert-butyl group, a tert-pentyl group, and a tert-octyl group are specifically exemplified.

Examples of the alkyl group having 1 to 5 carbon atoms in X include a methyl group, an ethyl group, a n-propyl group, an isopropyl group, a n-butyl group, a sec-butyl group, a tert-butyl group, a n-pentyl group, a 2-methyl-butyl group, a 3-methyl butyl group, a 2-ethyl-propyl group.

Examples of the alkoxy group having 1 to 5 carbon atoms in X include a methoxy group, an ethoxy group, a n-propoxy group, an isopropoxy group, a n-butoxy group, a sec-butoxy group, a tert-butoxy group, a n-pentyloxy group, a 2-methyl-butoxy group, a 3-methyl butoxy group, a 2-ethyl-propoxy group.

X preferably denotes a hydrogen atom, a fluorine atom, a chlorine atom, or a methyl group, and more preferably denotes a hydrogen atom, a fluorine atom, or a chlorine atom.

As another preferred aspect of the present invention, a triazine-based ultraviolet absorbent is preferably used in an optical film containing a polyimide-based polymer (in particular, polyimide and polyamideimide). Specifically, the compound represented by the following formula (II) is exemplified. Specific examples of the compound represented by the following formula (II) include the trade name “LA46” (2-(4,6-diphenyl-1,3,5-triazine-2-yl)-5-[2-(2-ethylhexanoyl oxy) ethoxy]phenol) manufactured by ADEKA Corporation, the trade names “Tinuvin (registered trademark) 400” (2-[4-[2-hydroxy-3-tridecyloxypropyl]oxy]-2-hydroxyphenyl]-4,6-bis(2,4-dimethylphenyl)-1,3,5-triazine and 2-[4-[2-hydroxy-3-didecyloxypropyl]oxy]-2-hydroxyphenyl]-4, 6-bis(2,4-dimethylphenyl)-1,3,5-triazine), “Tinuvin (registered trademark) 405” (2-[4-[(2-hydroxy-3-(2′-ethyl)hexyl)oxy]-2-hydroxyphenyl]-4,6-bis(2,4-dimethylphenyl)-1,3,5-triazine), “Tinuvin (registered trademark) 460” (2,4-Bis(2-hydroxy-4-butyloxyphenyl)-6-(2,4-bis-butyloxyphenyl)-1,3,5-triazine), and “Tinuvin (registered trademark) 479” (the structure not disclosed (hydroxyphenyltriazine-based ultraviolet absorbent)) all manufactured by BASF Japan Ltd., and the trade name “KEMISORB (registered trademark) 102” (2-[4,6-bis(2,4-dimethylphenyl)-1,3,5-triazine-2-yl]-5-(n-octyloxy)phenol) manufactured by Chemipro Kasei Kaisha, Ltd. These can be used alone or in combination of two or more kinds thereof. Preferred is LA46 (2-(4,6-diphenyl-1,3,5-triazine-2-yl)-5-[2-(2-ethylhexanoyl oxy)ethoxy]phenol).

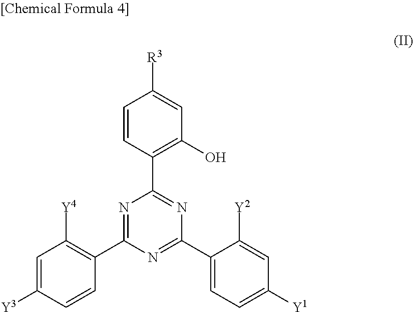

In the formula (II), Y¹ to Y⁴ each independently denote a hydrogen atom, a fluorine atom, a chlorine atom, a hydroxy group, an alkyl group having 1 to 20 carbon atoms, or an alkoxy group having 1 to 20 carbon atoms, preferably denote a hydrogen atom, an alkyl group having 1 to 12 carbon atoms, or an alkoxy group having 1 to 12, and more preferably denote a hydrogen atom. In the formula (II),

R³ denotes a hydrogen atom, a hydrocarbon group having 1 to 20 carbon atoms, an alkoxy group having one oxygen atom and 1 to 20 carbon atoms, or an alkoxy group having 1 to 4 carbon atoms substituted with an alkyl keto oxy group having 1 to 12 carbon atoms,
preferably an alkoxy group having one oxygen atom and 1 to 12 carbon atoms or an alkoxy group having 2 to 4 carbon atoms substituted with an alkyl keto oxy group having 8 to 12 carbon atoms, and more preferably an alkoxy group having 2 to 4 carbon atoms and substituted with an alkyl keto oxy group having 8 to 12 carbon atoms.

Examples of the hydrocarbon group having 1 to 20 carbon atoms in R³ include a methyl group, an ethyl group, a n-propyl group, an isopropyl group, a n-butyl group, a sec-butyl group, a tert-butyl group, a n-pentyl group, a n-hexyl group, a n-heptyl group, a n-octyl group, a n-nonyl group, a n-decyl group, a n-dodecyl group, a n-undecyl group.

When such a compound is used as an ultraviolet absorbent, predetermined light absorption characteristics can be obtained by regulating the content of the ultraviolet absorbent in an optical film. A level of an appropriate additive amount can be determined based on a value calculated by the following formula (Mathematical Formula (1)) with the use of the molar extinction coefficient ε₃₈₀ [L/mol·cm] at 380 nm of an ultraviolet absorbent to be used.

ε₃₈₀*[(x/(x+100)*10³)*d/w]*(L*10⁻⁴)=log(Tₚₛ)+log(T_{psU}) Mathematical Formula (1)

x: the number of parts by mass of an ultraviolet absorbent with respect to 100 parts by weight of the total amount of a polyimide-based polymer, polyamide, and an inorganic material

d: specific gravity [g/cm³] of a film to which an ultraviolet absorbent is to be added

w: molecular weight of an ultraviolet absorbent

L: film thickness [μm]

Tₚₐ: light transmittance [%] at 380 nm of a film to which an ultraviolet absorbent is to be added

T_{psU}: target value [%] of the light transmittance at 380 nm of a film added with an ultraviolet absorbent

It is preferable, from the viewpoint of suppressing an adverse possibility that characteristics of a film are significantly deteriorated, that the addition amount can be suppressed, and a compound to be used as an ultraviolet absorbent is preferably a compound whose molar extinction coefficient at 380 nm is not less than 1000 L/mol·cm. The compound to be used as an ultraviolet absorbent is more preferably a compound whose molar extinction coefficient at 380 nm is not less than 1500 L/mol·cm and still more preferably a compound whose molar extinction coefficient at 380 nm is not less than 2000 L/mol·cm.

On the other hand, in order to suppress an excessive increase in YI value even if a suitable amount of an ultraviolet absorbent is added to attain an object for suppressing a water absorption rate, it is important that an absorption coefficient at 400 nm is not considerably high. A compound to be used as an ultraviolet absorbent is preferably a compound whose molar extinction coefficient at 400 nm is not more than 2000 L/mol·cm and more preferably a compound whose molar extinction coefficient at 400 nm is not more than 1000 L/mol·cm. The compound to be used as an ultraviolet absorbent is still more preferably a compound whose molar extinction coefficient at 400 nm is not more than 500 L/mol·cm and most preferably a compound whose molar extinction coefficient at 400 nm is not more than 250 L/mol·cm.

The ultraviolet absorbent can be selected in consideration of a viewpoint of heat resistance. When the ultraviolet absorbent has high heat resistance, high heat resistance inherent in a polyimide-based polymer and polyamide can be satisfactorily effectively used. From this point of view, 1% weight reduction temperature of the ultraviolet absorbent is preferably not less than 180° C. and more preferably not less than 200° C. The 1% weight reduction temperature can be measured by thermogravimetric analysis.

The polyimide-based polymer or polyamide contained in the optical film according to this embodiment may be those soluble in a solvent (polar solvent) used for formation of the optical film. In the formation of the optical film containing the polyimide-based polymer or polyamide, it is possible to use, for example, amide-based solvents such as N,N-dimethylformamide and N,N-dimethylacetamide; lactone-based solvents such as γ-butyrolactone and γ-valerolactone; sulfur-containing-based solvents such as dimethylsulfone, dimethylsulfoxide, and sulfolane; and carbonate-based solvents such as ethylene carbonate and propylene carbonate. Among those solvents, the amide-based solvents or the lactone-based solvents are preferably used. These solvents may be used alone, or two or more kinds of them may be mixed and used. The ultraviolet absorbent is dissolved in a solution prepared by dissolving a polyimide-based polymer and/or polyamide in these solvents, whereby a varnish for forming an optical film can be obtained.

The polyimide-based polymer according to this embodiment can be produced by using, as main raw materials, a tetracarboxylic compound and a diamine compound to be described later and has a repeating structural unit represented by the following formula (10). Here, G denotes a tetravalent organic group, and A denotes a divalent organic group. G and/or A may include different two or more types of the structures represented by the formula (10). The polyimide-based polymer according to this embodiment may include structures represented by the formulae (11), (12), and (13) as long as various physical properties of a polyimide-based polymer film to be obtained are not impaired.

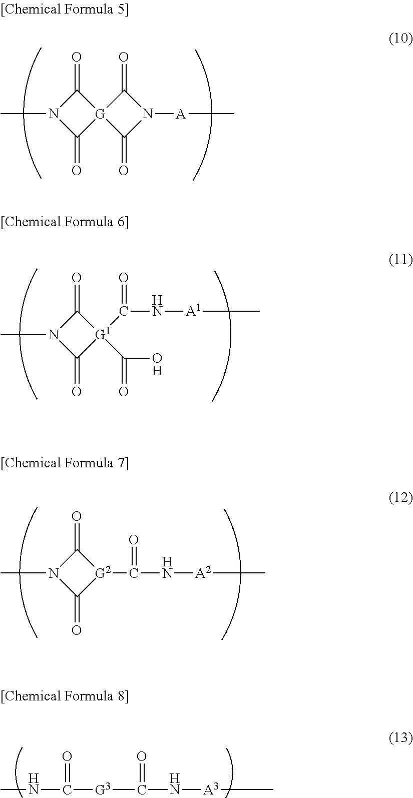

G and G¹ denote tetravalent organic groups and preferably organic groups optionally substituted with a hydrocarbon group or a fluorine-substituted hydrocarbon group, The above organic groups can be an organic groups having 4 to 40 carbon atoms. The above hydrocarbon group or the fluorine-substituted hydrocarbon group can have 1 to 8 carbon atoms. Examples of G and G¹ include a group represented by the following formula (20), (21), (22), (23), (24), (25), (26), (27), (28), or (29) and a tetravalent chain hydrocarbon group having not more than 6 carbon atoms are exemplified. In the formulae, “*” denotes a bonding site, and Z denotes a single bond, —O—, —CH₂—, —CH₂—CH₂—, —CH(CH₃)—, —C(CH₃)₂—, —C(CF₃)₂—, —Ar—, —SO₂—, —CO—, —O—Ar—O—, —Ar—O—Ar—, —Ar—CH₂—Ar—, —Ar—C(CH₃)₂—Ar—, or —Ar—SO₂—Ar—. Ar denotes an arylene group having 6 to 20 carbon atoms optionally substituted with fluorine atoms and specific examples thereof include a phenylene group, a naphthalene group and a group having a fluorene ring. From viewpoint of suppressing yellow index of the produced film, a group represented by the following formula (20), (21), (22), (23), (24), (25), (26), or (27) is preferred.

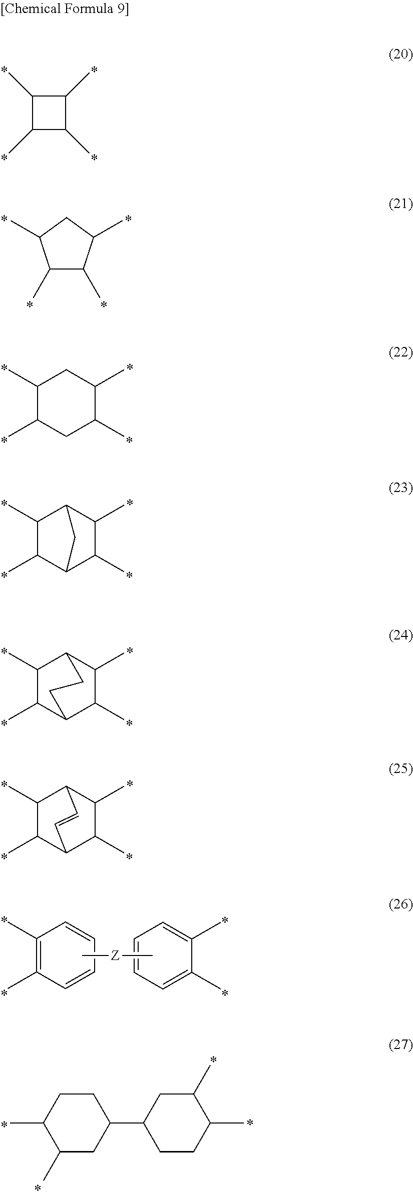

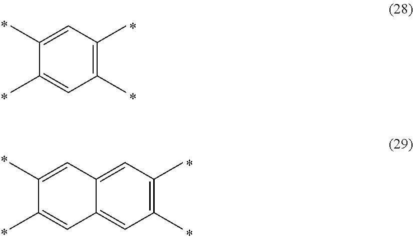

G² denotes a trivalent organic group and preferably an organic group optionally substituted with a hydrocarbon group or a fluorine-substituted hydrocarbon group. The above organic groups can be an organic groups having 4 to 40 carbon atoms. The above hydrocarbon group or the fluorine-substituted hydrocarbon group can have 1 to 8 carbon atoms. Examples of G² includes a group in which any one of bonding sites of groups represented by the above formulae (20), (21), (22), (23), (24), (25), (26), (27), (28), and (29) is replaced by a hydrogen atom and a trivalent chain hydrocarbon group having not more than 6 carbon atoms are exemplified.

G³ denotes a bivalent organic group and preferably an organic group optionally substituted with a hydrocarbon group or a fluorine-substituted hydrocarbon group. The above organic groups can be an organic groups having 4 to 40 carbon atoms. The above hydrocarbon group or the fluorine-substituted hydrocarbon group can have 1 to 8 carbon atoms. Examples of G³ includes a group in which, among the bonding sites of the groups represented by the above formulae (20), (21), (22), (23), (24), (25), (26), (27), (28), and (29), two of them not adjacent to each other are replaced by hydrogen atoms and a chain hydrocarbon group having not more than 6 carbon atoms are exemplified.

A, A¹, A², and A³ each denote a bivalent organic group and preferably denote an organic group optionally substituted with a hydrocarbon group or a fluorine-substituted hydrocarbon group. The above organic groups can be an organic groups having 4 to 40 carbon atoms. The above hydrocarbon group or the fluorine-substituted hydrocarbon group can have 1 to 8 carbon atoms. Examples of A, A¹, A², and A³ include groups represented by the following formulae (30), (31), (32), (33), (34), (35), (36), (37), and (38); groups in which these groups are substituted with a methyl group, a fluoro group, a chloro group, or a trifluoromethyl group; and a chain hydrocarbon group having not more than 6 carbon atoms. In the formulae, “*” denotes a bonding site, and Z¹, Z², and Z³ each independently denote a single bond, —O—, —CH₂—, —CH₂—CH₂—, —CH(CH₃)—, —C(CH₃)₂—, —C(CF₃)₂—, —SO₂—, or —CO—. As one example, Z¹ and Z³ may be —O—, and Z² may be —CH₂—, —C(CH₃)₂—, —C(CF₃)₂—, or —SO₂—. Z¹ and Z², and Z² and Z³ are each preferably located at a meta position or a para position with respect to each ring.

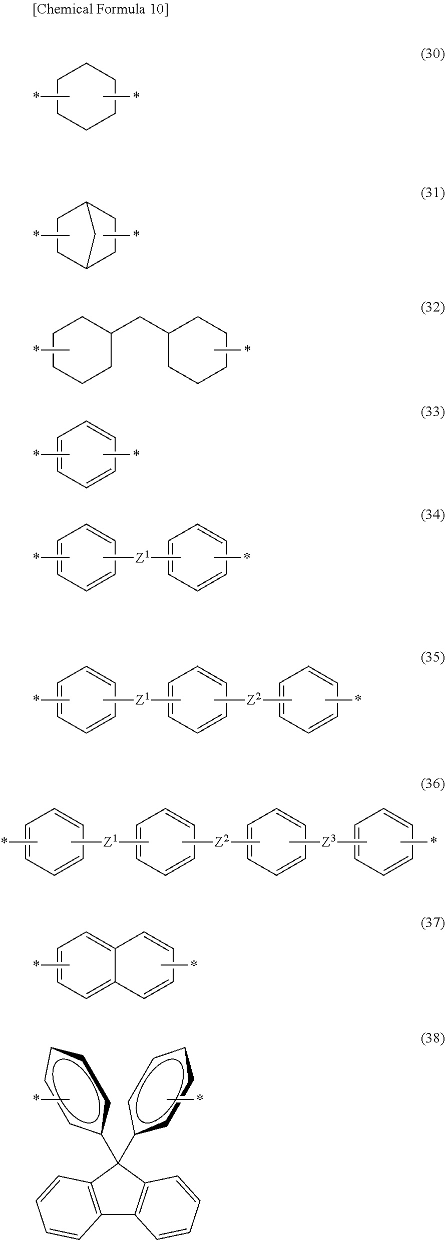

Polyamide according to this embodiment is a polymer mainly containing the repeating structural unit represented by the above formula (13). Preferred and specific examples are the same as given in G³ and A³ in the polyimide-based polymer. The polyamide may include two or more types of the structures having different G³ and/or A³ and represented by the formula (13)

A polyimide-based polymer is obtained by polycondensation of diamine and a tetracarboxylic compound (such as tetracarboxylic dianhydride), for example, and can be synthesized in accordance with the method disclosed in JP-A-2006-199945 or JP-A-2008-163107, for example. Examples of commercially available products of polyimide-based polymer include Neopulim manufactured by Mitsubishi Gas Chemical Co., Inc.

Examples of a tetracarboxylic compound used for synthesis of polyimide include aromatic tetracarboxylic compounds such as aromatic tetracarboxylic dianhydride and aliphatic tetracarboxylic compounds such as aliphatic tetracarboxylic dianhydride. The tetracarboxylic compound may be used alone, or two or more kinds thereof may be mixed and used. The tetracarboxylic compound may be a tetracarboxylic compound analog such as an acid chloride compound, in addition to a dianhydride.

Specific examples of the aromatic tetracarboxylic dianhydride include 4,4′-oxydiphthalic dianhydride, 3,3′,4,4′-benzophenonetetracarboxylic dianhydride, 2,2′,3,3′-benzophenonetetracarboxylic dianhydride, 3,3′,4,4′-biphenyltetracarboxylic dianhydride, 2,2′,3,3′-biphenyltetracarboxylic dianhydride, 3,3′,4,4′-diphenylsulfonetetracarboxylic dianhydride, 2,2-bis(3,4-dicarboxyphenyl)propane dianhydride, 2,2-bis(2,3-dicarboxyphenyl)propane dianhydride, 2,2-bis(3,4-dicarboxyphenoxyphenyl)propane dianhydride, 4,4′-(hexafluoroisopropylidene)diphthalic dianhydride, 1,2-bis(2,3-dicarboxyphenyl)ethane dianhydride, 1,1-bis(2,3-dicarboxyphenyl)ethane dianhydride, 1,2-bis(3,4-dicarboxyphenyl)ethane dianhydride, 1,1-bis(3,4-dicarboxyphenyl)ethane dianhydride, bis(3,4-dicarboxyphenyl)methane dianhydride, bis(2,3-dicarboxyphenyl)methane dianhydride, 4,4′-(p-phenylenedioxy)diphthalic dianhydride, 4,4′-(m-phenylenedioxy)diphthalic dianhydride, and 2,3,6,7-naphthalenetetracarboxylic dianhydride. Preferred are 4,4′-oxydiphthalic dianhydride, 3,3′,4,4′-benzophenonetetracarboxylic dianhydride, 2,2′,3,3′-benzophenonetetracarboxylic dianhydride, 3,3′,4,4′-biphenyltetracarboxylic dianhydride, 2,2′,3,3′-biphenyltetracarboxylic dianhydride, 3,3′,4,4′-diphenylsulfonetetracarboxylic dianhydride, 2,2-bis(3,4-dicarboxyphenyl)propane dianhydride, 2,2-bis(2,3-dicarboxyphenyl)propane dianhydride, 2,2-bis(3,4-dicarboxyphenoxyphenyl)propane dianhydride, 4,4′-(hexafluoroisopropylidene)diphthalic dianhydride, 1,2-bis(2,3-dicarboxyphenyl)ethane dianhydride, 1,1-bis(2,3-dicarboxyphenyl)ethane dianhydride, 1,2-bis(3,4-dicarboxyphenyl)ethane dianhydride, 1,1-bis(3,4-dicarboxyphenyl)ethane dianhydride, bis(3,4-dicarboxyphenyl)methane dianhydride, bis(2,3-dicarboxyphenyl)methane dianhydride, 4,4′-(p-phenylenedioxy)diphthalic dianhydride, 4,4′-(m-phenylenedioxy)diphthalic dianhydride, and 2,3,6,7-naphthalenetetracarboxylic dianhydride. These can be used alone or in combination of two or more kinds thereof.

Examples of the aliphatic tetracarboxylic dianhydride include cyclic or acyclic aliphatic tetracarboxylic dianhydride. The cyclic aliphatic tetracarboxylic dianhydride is a tetracarboxylic dianhydride having an alicyclic hydrocarbon structure, and specific examples thereof include cycloalkane-tetracarboxylic dianhydrides such as 1,2,4,5-cyclohexanetetracarboxylic dianhydride, 1,2,3,4-cyclobutanetetracarboxylic dianhydride, and 1,2,3,4-cyclopentanetetracarboxylic dianhydride, bicyclo[2.2.2]oct-7-ene-2,3,5,6-tetracarboxylic dianhydride, dicyclohexyl-3,3′-4, 4′-tetracarboxylicdianhydride, and their regioisomers. These can be used alone or in combination of two or more kinds thereof. Specific examples of the alicyclic aliphatic tetracarboxylic dianhydride include 1,2,3,4-butanetetracarboxylic dianhydride and 1,2,3,4-pentanetetracarboxylic dianhydride, and these can be used alone or in combination of two or more kinds thereof.

Among those tetracarboxylic dianhydrides, from viewpoints of high transparency and low colorability, 1,2,4,5-cyclohexanetetracarboxylic dianhydride, bicyclo[2.2.2]oct-7-ene-2,3,5,6-tetracarboxylic dianhydride, and 4,4′-(hexafluoroisopropylidene)diphthalic dianhydride are preferable.

The polyimide-based polymer according to this embodiment may be those further reacted with tetracarboxylic acid, tricarboxylic acid, dicarboxylic acid, and anhydrides and derivatives thereof, in addition to an anhydride of tetracarboxylic acid used for the synthesis of polyimide, as long as various physical properties of a polyimide-based polymer film to be obtained are not impaired.

Examples of a tricarboxylic compound include aromatic tricarboxylic compounds, aliphatic tricarboxylic compounds, acid chloride compounds similar thereto, and acid anhydrides, and two or more kinds thereof may be mixed and used. Specific examples include 1,2,4-benzenetricarboxylic acid anhydride; 2,3,6-naphthalenetricarboxylic acid-2,3-anhydride; and a compound in which phthalic anhydride and benzoic acid are bonded together through a single bond, —O—, —CH₂—, —C(CH₃)₂—, —C(CF₃)₂—, —SO₂—, or a phenylene group.

Examples of a dicarboxylic compound include aromatic dicarboxylic compounds, aliphatic dicarboxylic compounds, acid chloride compounds similar thereto, and acid anhydrides, and two or more kinds thereof may be mixed and used. Specific examples include terephthalic acid; isophthalic acid; naphthalenedicarboxylic acid; 4,4′-biphenyldicarboxylic acid; 3,3′-biphenyldicarboxylic acid; and a compound in which a dicarboxylic compound of a chain hydrocarbon having not more than 8 carbon atoms and two benzoic acids are bonded together through a single bond, —O—, —CH₂—, —C(CH₃)₂—, —C(CF₃)₂—, —SO₂—, or a phenylene group.

As diamine used for synthesis of polyimide, aliphatic diamine, aromatic diamine, or mixtures thereof may be used. In this embodiment, the “aromatic diamine” means a diamine containing an amino group directly bonded to an aromatic ring, which may also contain an aliphatic group or another substituent group as a part of a structure thereof. The aromatic ring may be a single ring or a condensed ring, and a benzene ring, a naphthalene ring, an anthracene ring, and a fluorene ring are exemplified. However, this invention is not limited thereto. Among them, the benzene ring is preferable. The “aliphatic diamine” means a diamine containing an amino group directly bonded to an aliphatic group, which may also contain an aromatic ring or another substituent group as a part of a structure thereof.

Examples of the aliphatic diamine include acyclic aliphatic diamines such as hexamethylenediamine and cyclic aliphatic diamines such as 1,3-bis(aminomethyl)cyclohexane, 1,4-bis(aminomethyl)cyclohexane, norbornanediamine, and 4,4′-diaminodicylcohexyl methane, and these can be used alone or in combination of two or more kinds thereof.

Examples of the aromatic diamine include aromatic diamines having one aromatic ring, such as p-phenylenediamine, m-phenylenediamine, 2,4-toluenediamine, m-xylylenediamine, p-xylylenediamine, 1,5-diaminonaphthalene, and 2, 6-diaminonaphthalene, and aromatic diamines having two or more aromatic rings, such as 4,4′-diaminodiphenyl methane, 4,4′-diaminodiphenyl propane, 4,4′-diaminodiphenyl ether, 3,4′-diaminodiphenyl ether, 3,3′-diaminodiphenyl ether, 4,4′-diaminodiphenyl sulfone, 3,4′-diaminodiphenyl sulfone, 3,3′-diaminodiphenyl sulfone, 1,4-bis(4-aminophenoxy)benzene, 1,3-bis(4-aminophenoxy)benzene, 4,4′-diaminodiphenyl sulfone, bis[4-(4-aminophenoxy)phenyl]sulfone, bis[4-(3-aminophenoxy)phenyl]sulfone, 2,2-bis[4-(4-aminophenoxy)phenyl]propane, 2,2-bis[4-(3-aminophenoxy)phenyl]propane, 2,2′-dimethylbenzidine, 2,2′-bis(trifluoromethyl)benzidine, 4,4′-bis(4-aminophenoxy)biphenyl, 4,4′-diaminodiphenyl ether, 3,4′-diaminodiphenyl ether, 4,4′-diaminodiphenyl methane, 9,9-bis(4-aminophenyl)fluorene, 9,9-bis(4-amino-3-methylphenyl)fluorene, 9,9-bis(4-amino-3-chlorophenyl)fluorene, and 9,9-bis(4-amino-3-fluorophenyl)fluorene. These can be used alone or in combination of two or more kinds thereof.

Among those diamines, from viewpoints of high transparency and low colorability, it is preferable to use one or more kinds selected from the group consisting of aromatic diamines having a biphenyl structure. It is more preferable to use one or more kinds selected from the group consisting of 2,2′-dimethylbenzidine, 2,2′-bis(trifluoromethyl)benzidine, 4,4′-bis(4-aminophenoxy)biphenyl, and 4,4′-diaminodiphenyl ether, and it is still more preferable to contain 2,2′-bis(trifluoro)benzidine.

A polyimide-based polymer and polyamide which are polymers containing at least one type of repeating structural unit represented by the formulae (10), (11), (12), or (13) are condensate polymers which are each a polycondensation product of diamine and at least one kind of compound included in the group consisting of a tetracarboxylic compound (tetracarboxylic compound analog such as an acid chloride compound and tetracarboxylic dianhydride), a tricarboxylic compound (tricarboxylic compound analog such as an acid chloride compound and tricarboxylic anhydride), and a dicarboxylic compound (dicarboxylic compound analog such as an acid chloride compound) As a starting material, in addition to them, a dicarboxylic compound (including analogs such as an acid chloride compound) may be further used. The repeating structural unit represented by the formula (11) is usually derived from diamines and a tetracarboxylic compound. The repeating structural unit represented by the formula (12) is usually derived from diamine and a tricarboxylic compound. The repeating structural unit represented by the formula (13) is usually derived from diamine and a dicarboxylic compound. Specific examples of diamine and the tetracarboxylic compound are as described above.

The polyimide-based polymer and polyamide according to this embodiment each have a weight average molecular weight within the range of 10,000 to 500,000 in terms of standard polystyrene. The weight average molecular weight is preferably within the range of 50,000 to 500,000 and more preferably within the range of 100,000 to 400,000. When the weight average molecular weight of the polyimide-based polymer and the polyamide is too small, properties of bending resistance in forming a film tends to be lower. The greater the weight average molecular weight of the polyimide-based polymer and the polyamide is, the greater the tendency that high bending resistance is likely to be exhibited in forming a film is. However, if the weight average molecular weight of the polyimide-based polymer and polyamide is too high, there is a tendency that viscosity of a varnish increases to deteriorate processability.

When the polyimide-based polymer and the polyamide each contain a fluorine-containing substituent group, there is a tendency that while the elastic modulus in forming a film increases, the YI value is reduced. If the elastic modulus of the film is high, flaws, wrinkles and the like tend to be suppressed. From the viewpoint of transparency of a film, the polyimide-based polymer and the polyamide preferably each have a fluorine-containing substituent group. Specific examples of the fluorine-containing substituent group include a fluoro group and a trifluoromethyl group.

The content of fluorine atoms in the polyimide-based polymer and the polyamide is preferably not less than 1% by mass and not more than 40% by mass and more preferably not less than 5% by mass and not more than 40% by mass based on the mass of the polyimide-based polymer or the polyamide.

The optical film according to this embodiment may further contain inorganic materials such as inorganic particles, in addition to the polyimide-based polymer and/or the polyamide.

Preferred examples of the inorganic material include silica particles and silicon compounds such as quaternary alkoxysilanes such as tetraethyl orthosilicate (TEOS), and silica particles are preferable from the viewpoint of varnish stability.

As silica particles according to this embodiment, a silica sol prepared by dispersing silica particles in an organic solvent or the like may be used, or a silica particle powder produced by a gas phase method may be used. From the viewpoint of easiness of handling, silica sol is preferably used.

The optical film may contain silica particles with an average primary particle size of 10 to 100 nm in an amount of not less than 10% by mass and not more than 60% by mass relative to the total mass of an optical film containing a polyimide-based polymer and/or polyamide and silica particles. The (average) primary particle size of silica particles in the optical film can be obtained by observation with a transmission electron microscope (TEM). A particle size distribution of the silica particles before formation of the optical film can be obtained by a commercially available laser diffraction type particle size distribution analyzer.

In the optical film according to this embodiment, the inorganic material is contained in an amount of not less than 0% by mass and not more than 90% by mass, preferably not less than 10% by mass and not more than 60% by mass, and more preferably not less than 20% by mass and not more than 50% by mass. If a compounding ratio of a polyimide-based polymer and/or polyamide, and an inorganic material (e.g. silicon material) is in the above range, there is a tendency that the transparency and mechanical strength of an optical film are easily simultaneously achieved.

The optical film according to this embodiment may further contain an additive in addition to the components described above. Examples of the additive include an antioxidant, a release agent, a stabilizer, a colorant such as a bluing agent, a flame retardant, a lubricant, and a leveling agent.

The thickness of the optical film according to this embodiment is suitably adjusted according to the application of a flexible device or the like to which the optical film is applied, and the thickness is usually 10 μm to 500 μm, preferably 15 μm to 200 μm, and more preferably 20 μm to 100 μm. In the optical film having such a constitution, there is a tendency that durability and flexibility are simultaneously achieved.

The optical film according to this embodiment may be a laminate formed by adding a functional layer such as a hard coat layer, an adhesive layer, and a hue adjustment layer.

The optical film according to this embodiment can be suitably used for a front plate of a flexible device member and the like. An applicable flexible device is not limited to a display device. For example, the film according to this embodiment can be adopted as a front plate for a solar cell having a substrate formed with a photoelectric conversion element and a front plate provided on a substrate surface. In this case, the solar cell can have excellent bending resistance as a whole.

In a flexible device comprising the optical film according to this embodiment, internal constructional elements such as a polarizing plate can be suitably protected by the optical film which is transparent, has less coloring, efficiently absorbs ultraviolet radiation, and has improved hygroscopic characteristics; therefore, the flexible device is excellent in visibility and can have high light resistance.

Next, an example of a method for manufacturing the optical film according to this embodiment will be described.

The varnish used in the manufacturing of the optical film according to this embodiment can be prepared by, for example, mixing and stirring a reaction liquid of a polyimide-based polymer and/or polyamide, the ultraviolet absorbent, the solvent, and the additive to be used if necessary, and/or the silica fine particles. The reaction liquid is obtained by selecting and reacting the tetracarboxylic compound, the diamine, or the other raw materials. Instead of the reaction liquid of a polyimide-based polymer and so on, a solution of a purchased polyimide-based polymer and so on or a solution of a purchased solid polyimide-based polymer and so on may be used.

Subsequently, the prepared varnish is applied on a substrate by, for example, roll-to-roll or batch processing to form a coating film. The coating film is dried to form a film, and then the film is peeled from the substrate, where by the optical film according to this embodiment is obtained. Examples of the substrate include a polyethylene terephthalate (PET) substrate, a SUS belt, and a glass substrate.

The coating film may be heated to be dried and/or baked. When the coating film is suitably heated and evaporated solvents which are contained therein at a temperature of 50° C. to 350° C. in an inert gas atmosphere or under a reduced pressure condition, the optical film can be obtained. The solvents are preferably eliminated.

The optical film according to this embodiment is particularly useful as a member such as a front plate constituting a flexible device. As a member of the flexible device, the optical film itself may be used, or a laminate film further comprising other layers than the optical film may be used. For example, functional layers stacked on one or both principal surfaces of the optical film may be provided.

The functional layer is a layer for imparting additional functions (performances) to the optical film, and the functions include surface hardness, adhesion, and hue adjustment.

### EXAMPLES

Hereinafter, the present invention will be more specifically described with reference to examples. However, this invention is not limited to those examples.

### 1. Ultraviolet Absorbent

The following ultraviolet absorbent was provided.
Trade name: Sumisorb 340 (2-(2-hydroxy-5-tert-octylphenyl)benzotriazole) manufactured by Sumitomo Chemical Co., Ltd.
Trade name: Sumisorb 350 (2-(2-hydroxy-3,5-di-tert-pentylphenyl)benzotriazole) manufactured by Sumitomo Chemical Co., Ltd.
Trade name: LA31 (2,2′-methylenebis[6-(2H-benzotriazole-2-yl)-4-(1,1,3,3-tetramethylbutyl)phenol] manufactured by ADEKA Corporation
Trade name: LA46 (2-(4,6-diphenyl-1,3,5-triazine-2-yl)-5-[2-(2-ethylhexanoyl oxy)ethoxy]phenol) manufactured by ADEKA Corporation

### (Measurement of Molar Extinction Coefficient of Ultraviolet Absorbent)

Table 1 shows the solubility at 25° C. of each ultraviolet absorbent with respect to N,N-dimethylacetamide (DMAc) and the molar extinction coefficient of each ultraviolet absorbent in a 20 mg/L toluene solution at 360 to 400 nm.

<Sumisorb 340, Sumisorb 350>

Measuring Device: UV-3600 (manufactured by Shimadzu Corporation)

Measured Concentration: 20 mg/L

Solvent: toluene

<LA31, LA46>

Measuring Device: V670 (manufactured by JASCO Corporation)

Measured Concentration: 20 mg/L

Solvent: toluene

TABLE 1

| | Solubility at | | | | | | |
|---|---|---|---|---|---|---|---|
| | 25° C. with | | | | | | |
| Ultraviolet | respect to DMAc | Molar extinction coefficient [L/mol · cm] | | | | | |
| absorbent | [g/100 g-DMAc] | 360 nm | 370 nm | 380 nm | 390 nm | 400 nm | 420 nm |
| Sumisorb | >10 | 13,100 | 7,700 | 2,200 | 320 | <50 | <50 |
| 340 | | | | | | | |
| Sumisorb | >10 | 13,900 | 9,700 | 4,800 | 1,200 | 210 | <50 |
| 350 | | | | | | | |
| LA31 | >10 | 27,300 | 19,800 | 9,000 | 1,400 | <50 | <50 |
| LA46 | >10 | 10000 | 3,000 | 160 | <50 | <30 | <30 |

### 2. Polyimide and Polyamideimide (Polyimide-Based Polymer)

Resin A: polyimide which is a copolymer of 4,4′-(hexafluoroisopropylidene)diphthalic anhydride (hereinafter referred to as 6FDA) and 2,2′-bis(trifluoromethyl)-4,4′-diaminodiphenyl (hereinafter referred to as TFMB)

Resin B: commercially available soluble polyimide (“KPI-MX300F” manufactured by Kawamura Sangyo Co., Ltd.)

Resin C: polyamideimide which is a copolymer of terephthaloyl chloride (hereinafter referred to as TPC), 6FDA, 4,4′-oxybis(benzoyl chloride) (hereinafter referred to as OBBC), and TFMB

### (Production Example 1) Production of Resin A

2.00 g of isoquinoline was introduced under a nitrogen atmosphere. Then, 375.00 g of γ-butyrolactone (hereinafter referred to as GBL) and 104.12 g of 2,2′-bis(trifluoromethyl)-4,4′-diaminodiphenyl (hereinafter referred to as TFMB) were introduced into a reaction container to be stirred and thus to be completely dissolved. 145.88 g of 4,4′-(hexafluoroisopropylidene)diphthalic anhydride (hereinafter referred to as 6FDA) was further added thereto, and then temperature rise started in an oil bath while stirring. The molar ratio of the added TFMB and 6FDA was 1.00:0.99, and the monomer concentration was 40 wt %. The temperature was raised to an internal temperature of 180° C., and then heating and stirring were further carried out for 4 hours. The resultant product was cooled to 155° C., and then GBL was added thereto, thus producing a polyimide varnish in which the solid content of polyimide was 24 wt %.

### (Production Example 2) Production of Resin C

Under a nitrogen gas atmosphere, 52 g (162.38 mmol) of TFMB and 849.23 g of DMAc were charged into a 1 L separable flask equipped with a stirring blade, and TFMB was dissolved in DMAc while stirring at a room temperature. Then, 14.45 g (32.52 mmol) of 6FDA was charged into the flask and stirred for 3 hours at a room temperature. After that, 4.80 g (16.26 mmol) of OBBC was charged into the flask, then 23.11 g (113.84 mmol) of TPC was charged into the flask, and stirring was carried out at a room temperature for 1 hour. Then, 9.98 g (126.20 mmol) of pyridine and 13.28 g (130.10 mmol) of acetic anhydride were charged into the flask to be stirred at a room temperature for 30 minutes. Then, the temperature was raised to 70° C. with the use of an oil bath, and stirring was further carried out for 3 hours to obtain a reaction liquid.

The obtained reaction liquid was cooled to a room temperature and introduced into a large amount of methanol in a thread-like manner, thus collecting a precipitated precipitate. The precipitate was immersed in methanol for 6 hours and then washed with methanol. Then, the precipitate was dried under reduced pressure at 100° C. to obtain a polyamideimide resin (3)

### 3. Polyimide Film or Polyamideimide Film (Optical Film)

### Example 1

The polyimide varnish produced in Production Example 1 was diluted with γ-butyrolactone to prepare a polyimide varnish having a concentration of 16% by mass. An N,N-dimethylacetamide solution of Sumisorb 340 (ultraviolet absorbent) was mixed and then stirred for 30 minutes. The ultraviolet absorbent was contained in an amount of 3 parts by mass based on 100 parts by mass of polyimide.

The obtained polyimide varnish was applied on a glass substrate, heated at 50° C. for 30 minutes, and then heated at 140° C. for 10 minutes, whereby a solvent was removed from a coating film to form a film. The film peeled from the glass substrate was attached to a metal frame, and this was heated at 210° C. for 1 hour, thus obtaining a polyimide film having a haze of 0.1%, YI of 2.2, and a thickness of 80 μm.

### Example 2

A γ-butyrolactone solution containing polyimide (resin B) produced at a concentration of 16% by mass, a dispersion liquid containing silica particles having a concentration of 30% by mass and γ-butyrolactone, a dimethylacetamide solution of alkoxy silane having an amino group, and an N,N-dimethylacetamide solution of Sumisorb 350 (ultraviolet absorbent) were mixed and then stirred for 30 minutes, thus preparing a varnish in which a mass ratio of polyimide and silica particles was 6:4. The ultraviolet absorbent was contained in an amount of 3 parts by mass based on 100 parts by mass of a total amount of polyimide and the silica particles.

The obtained polyimide varnish was formed into a film as in Example 1, thus obtaining a polyimide film having a haze of 0.6%, YI of 3.4, and a thickness of about 50 μm.

### Example 3

An N,N-dimethylacetamide solution of LA31 (ultraviolet absorbent) was mixed with a γ-butyrolactone solution containing polyimide (resin B) produced at a concentration of 16% by mass and then stirred for 30 minutes. The ultraviolet absorbent was contained in an amount of 1 part by mass based on 100 parts by mass of a total amount of polyimide and silica particles.

The obtained polyimide varnish was formed into a film as in Example 1, thus obtaining a polyimide film having a haze of 0.1%, YI of 2.0, and a thickness of about 80 μm.

### Example 4

An N,N-dimethylacetamide solution of LA46 (ultraviolet absorbent) was mixed with a γ-butyrolactone solution containing polyimide (resin B) produced at a concentration of 16% by mass and then stirred for 30 minutes. The ultraviolet absorbent was contained in an amount of 3 parts by mass based on 100 parts by mass of a total amount of polyimide and silica particles.

The obtained polyimide varnish was formed into a film as in Example 1, thus obtaining a polyimide film having a haze of 0.1%, YI of 1.8, and a thickness of about 80 m.

### Example 5

Polyamideimide varnish produced in Production Example 2 was diluted with γ-butyrolactone to prepare a polyamideimide varnish having a concentration of 16% by mass. An N,N-dimethylacetamide solution of Sumisorb 340 (ultraviolet absorbent) was mixed and then stirred for 30 minutes. The ultraviolet absorbent was contained in an amount of 5 parts by mass based on 100 parts by mass of polyimide.

The obtained polyamideimide varnish was formed into a film as in Example 1, thus obtaining a polyimide film having a haze of 0.3%, YI of 2.0, and a thickness of about 50 m.

### Comparative Example 1

A polyimide film having a haze of 0.2%, YI of 2.2, and a thickness of about 80 μm was obtained as in Example 1 except that an N,N-dimethylacetamide solution of Sumisorb 340 (ultraviolet absorbent) was not mixed.

### Comparative Example 2

A polyimide film having a haze of 0.3%, YI of 2.9, and a thickness of about 50 μm was obtained as in Example 2 except that an N,N-dimethylacetamide solution of Sumisorb 350 (ultraviolet absorbent) was not mixed.

### Comparative Example 3

A polyimide film having a haze of 0.1%, YI of 1.5, and a thickness of about 80 μm was obtained as in Example 4 except that an N,N-dimethylacetamide solution of LA46 (ultraviolet absorbent) was not mixed.

### Comparative Example 4

A polyamideimide film having a haze of 0.2%, YI of 1.7, and a thickness of about 50 μm was obtained as in Example 5 except that an N,N-dimethylacetamide solution of Sumisorb 340 (ultraviolet absorbent) was not mixed.

### (Evaluation)

### Haze

A polyimide film was set in a sample holder of a full-automatic direct-reading haze computer (HGM-2DP manufactured by Suga Test Instruments Co., Ltd.), and the haze of the polyimide film was measured.

It was determined that Haze<1 is represented by O and Haze≧1 is represented by x, in the Table 2.

### Yellow Index (YI Value)

The yellow index (YI value) of the polyimide film was measured using a UV-VIS-NIR spectrophotometer V-670 manufactured by JASCO Corporation. Background measurement was performed without sample, and then the polyimide film was set in a sample holder. The transmittance with respect to light at 300 nm to 800 nm was measured, and tristimulus values (X, Y, and Z) were obtained. The YI value was calculated based on the following formula:

YI value=100×(1.2769X−1.0592Z)/Y

It was determined that YI<5 is represented by O and YI≧5 is represented by x

### Light Transmittance

The transmittance of the optical film with respect to light at 300 nm to 800 nm was measured using a UV-VIS-NIR spectrophotometer V-670 manufactured by JASCO Corporation. The light transmittances at 380 nm, 390 nm, and 420 nm were found from the measurement results.

### Water Absorption Rate

In the water absorption rate of an optical film (a polyimide film or a polyamideimide film), a sample weight was measured under an AIR atmosphere with controlled temperature and humidity, and a weight change rate was obtained from a change amount from the weight before humidification. In the measurement, a thermal analyzer (TG/DTA6200 manufactured by Seiko Instruments and Electronics Co., Ltd.) of specifications for high temperature and high humidity was used. Two sample dishes were set in a balance beam, and a test piece (about 15 mm×15 mm) was placed in one sample dish. A sample temperature was regulated in a circulating thermostatic bath for controlling sample temperature, and humidity conditioning was performed while flowing dry air through a hot water circulating furnace at 100 mL/min. Measurement temperature and humidity were controlled stepwise to 25° C. with 0% RH, which is without humidification, 25° C. with 50% RH, 60° C. with 90% RH, and 85° C. with 85% RH. The test piece was left to stand in a stationary state until the sample weight was stabilized in each temperature and humidity condition, and then the sample weight was measured. The water absorption rate (weight change) % was calculated by the following formula:

Water absorption amount (mg)=sample weight (mg) at each temperature and humidity−sample weight (mg) without humidification

Water absorption rate (%)=water absorption amount (mg)+sample weight (mg) without humidification×100

By using the above formula, the water absorption rate at 25° C. with 50% RH was obtained as the water absorption rate 1, the water absorption rate at 60° C. with 90% RH was obtained as the water absorption rate 2, and the water absorption rate at 85° C. with 85% RH was obtained as the water absorption rate 3. Further, water absorption coefficient was calculated by the following formula:

water absorption coefficient=(the water absorption rate 1+the water absorption rate 2+the water absorption rate 3)/(the sum of the water absorption rate 1 through 3 of a film without containing ultraviolet absorbent)

TABLE 2

| | | | | | | Water | Water | Water | |
|---|---|---|---|---|---|---|---|---|---|
| | | | | | | absorption | absorption | absorption | Water |
| | | | Tr (%) | Tr (%) | Tr (%) | rate 1 | rate 2 | rate 3 | absorption |
| | YI | Haze | (380) | (390) | (420) | (%) | (%) | (%) | coefficient |
| Example 1 | ◯ | ◯ | 0.3 | 13.6 | 85.3 | 0.5 | 1.2 | 1.1 | 0.82 |
| Comparative | ◯ | ◯ | 29.3 | 56.4 | 86.9 | 0.6 | 1.5 | 1.3 | 1.00 |
| Example 1 | | | | | | | | | |
| Example 2 | ◯ | ◯ | 0.2 | 5.8 | 81.4 | 0.6 | 1.2 | 1.1 | 0.78 |
| Comparative | ◯ | ◯ | 48.1 | 67.0 | 85.8 | 0.7 | 1.6 | 1.4 | 1.00 |
| Example 2 | | | | | | | | | |
| Example 3 | ◯ | ◯ | 0.9 | 15.0 | 85.6 | 0.6 | 1.4 | 1.2 | 0.91 |
| Example 4 | ◯ | ◯ | 4.4 | 31.5 | 86.3 | 0.6 | 1.2 | 1.1 | 0.83 |
| Comparative | ◯ | ◯ | 29.8 | 58.1 | 88.2 | 0.7 | 1.5 | 1.3 | 1.00 |
| Example 3 | | | | | | | | | |
| Example 5 | ◯ | ◯ | 0.7 | 20.4 | 85.1 | 1.4 | 2.5 | 2.2 | 0.78 |
| Comparative | ◯ | ◯ | 48.0 | 70.8 | 86.9 | 1.9 | 3.2 | 2.7 | 1.00 |
| Example 4 | | | | | | | | | |

As shown in Table 2, it was confirmed that when an ultraviolet absorbent (Sumisorb 340 (2-(2-Hydroxy-5-tert-octylphenyl)benzotriazole), Sumisorb 350 (2-(2-Hydroxy-3,5-di-tert-pentylphenyl)benzotriazole), LA46 (2-(4,6-diphenyl-1,3,5-triazine-2-yl)-5-[2-(2-ethylhexanoyl oxy)ethoxy]phenol), or LA31 (2,2′-methylenebis[6-(2H-benzotriazole-2-yl)-4-(1,1,3,3-tetramethylbutyl)phenol])) having relatively high solubility with respect to N,N-dimethylacetamide was blended in such an amount that allows the light transmittances at 380 nm and 420 nm to fall within the specified ranges, it was possible to obtain an optical film which has less coloring (YI<5) and satisfactorily absorbs ultraviolet radiation while maintaining high transparency (Haze<1). Further, it was confirmed that the water absorption rate of the film was reduced, and also from this point, it was confirmed that this film was suitable as an optical film used for a front plate of a flexible device member or the like.

What is claimed is:

1. An optical film comprising: at least one selected from the group consisting of a polyimide-based polymer and polyamide; and an ultraviolet absorbent, wherein a light transmittance at 380 nm is not more than 5%, and a light transmittance at 420 nm is not less than 80%.

2. The optical film according to claim 1, wherein the light transmittance is not more than 32% at 390 nm.

3. The optical film according to claim 1, wherein the light transmittance is not more than 30% at 390 nm.

4. The optical film according to claim 1, wherein the polyimide-based polymer is polyimide soluble in a polar solvent, and a yellow index of the optical film is not more than 5.

5. The optical film according to claim 1, wherein the ultraviolet absorbent is a compound to be dissolved in an amount of not less than 1 g in 100 g of N,N-dimethylacetamide at 25° C.

6. The optical film according to claim 1, wherein a molar extinction coefficient at 380 nm of the ultraviolet absorbent is not less than five times the molar extinction coefficient at 400 nm.

7. The optical film according to claim 1, wherein the ultraviolet absorbent contains one or more kinds of compounds selected from the group consisting of a benzotriazole derivative and a 1,3,5-triphenyltriazine derivative.

8. The optical film according to claim 6, wherein the ultraviolet absorbent is one or more kinds of compounds selected from the group consisting of a compound represented by the formula (I);
2-[2-hydroxy-3-(3,4,5,6-tetrahydrophthalimide-methyl)-5-met hylphenyl]benzotriazole; 2,2′-Methylenebis[6-(2H-benzotriazole-2-yl)-4-tert-octylphenol];
Reaction products of methyl 3-(3-(2H-benzotriazole-2-yl)-5-tert-butyl-4-hydroxyphenyl) propionate/PEG 300;
and a compound represented by the formula (II), 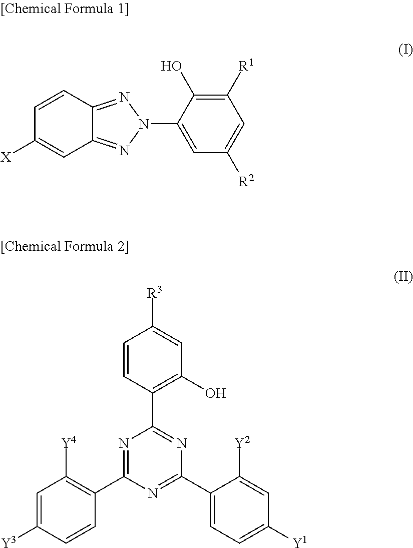
in the formula (I), X denotes a hydrogen atom, a fluorine atom, a chlorine atom, an alkyl group having 1 to 5 carbon atoms, or an alkoxy group having 1 to 5 carbon atoms, R¹ and R² each denote a hydrogen atom or a hydrocarbon group having 1 to 20 carbon atoms, and at least one of R¹ and R² is a hydrocarbon group;
in the formula (II), Y¹ to Y⁴ each independently denote a hydrogen atom, a fluorine atom, a chlorine atom, a hydroxy group, an alkyl group having 1 to 20 carbon atoms, or an alkoxy group having 1 to 20 carbon atoms, and R³ denotes a hydrogen atom, a hydrocarbon group having 1 to 20 carbon atoms, an alkoxy group having one oxygen atom and 1 to 20 carbon atoms, or an alkoxy group having 1 to 4 carbon atoms substituted with an alkyl keto oxy group having 1 to 12 carbon atoms.

9. The optical film according to claim 1, wherein silica particles having an average primary particle size of 10 to 100 nm are contained in an amount of not less than 10% by mass and not more than 60% by mass of an optical film containing silica particles and at least one selected from a polyimide-based polymer and polyamide.

10. The optical film according to claim 1, which is used for a front plate of a flexible device member.

11. A flexible device comprising the optical film according to claim 1.

12. The optical film according to claim 2, wherein the polyimide-based polymer is polyimide soluble in a polar solvent, and a yellow index of the optical film is not more than 5.

13. The optical film according to claim 2, wherein a molar extinction coefficient at 380 nm of the ultraviolet absorbent is not less than five times the molar extinction coefficient at 400 nm.

14. The optical film according to claim 2, wherein the ultraviolet absorbent contains one or more kinds of compounds selected from the group consisting of a benzotriazole derivative and a 1,3,5-triphenyltriazine derivative.

15. The optical film according to claim 2, wherein silica particles having an average primary particle size of 10 to 100 nm are contained in an amount of not less than 10% by mass and not more than 60% by mass of an optical film containing silica particles and at least one selected from a polyimide-based polymer and polyamide.

16. The optical film according to claim 12, wherein a molar extinction coefficient at 380 nm of the ultraviolet absorbent is not less than five times the molar extinction coefficient at 400 nm.

17. The optical film according to claim 12, wherein the ultraviolet absorbent contains one or more kinds of compounds selected from the group consisting of a benzotriazole derivative and a 1,3,5-triphenyltriazine derivative.

18. The optical film according to claim 12, wherein silica particles having an average primary particle size of 10 to 100 nm are contained in an amount of not less than 10% by mass and not more than 60% by mass of an optical film containing silica particles and at least one selected from a polyimide-based polymer and polyamide.

19. The optical film according to claim 16, wherein silica particles having an average primary particle size of 10 to 100 nm are contained in an amount of not less than 10% by mass and not more than 60% by mass of an optical film containing silica particles and at least one selected from a polyimide-based polymer and polyamide.

20. The optical film according to claim 17, wherein silica particles having an average primary particle size of 10 to 100 nm are contained in an amount of not less than 10% by mass and not more than 60% by mass of an optical film containing silica particles and at least one selected from a polyimide-based polymer and polyamide.
